(19) United States
(12) Patent Application Publication
(10) Pub. No.: US 2008/0088239 A1
(43) Pub. Date: Apr. 17, 2008

(54) Arc Tube, Light Source Apparatus, and Projector

(75) Inventor: Takeshi TAKEZAWA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/866,730

(22) Filed: Oct. 3, 2007

(30) Foreign Application Priority Data
Oct. 16, 2006 (JP) 2006-281144

(51) Int. Cl. H01J 17/18; G03B 21/00

(52) U.S. Cl. 313/623; 353/31

(57) ABSTRACT

An arc tube includes ate last one conductive member including a lead wire extending to the outside, an electrode extending to the inside and a metal foil member that is interposed between the lead wire and the electrode and electrically connects the lead wire to the electrode; a sealed tube having a body portion that encloses at least a tip portion of the electrode in an internal source; and a sealed tube having a fixing portion for fixing at least the metal foil member of the conductive member and a root portion of the electrode in a buried manner; wherein the electrode is sandwiched in the root portion from both sides perpendicular to an axis of the electrode using an end portion of the metal foil member.

### BACKGROUND

1. Technical Field

The present invention relates to a discharge-type arc tube used for an illumination light source and the like, and a light source apparatus and a projector, which incorporate such an arc tube.

2. Related Art

As a light source apparatus for a projector, an apparatus is given, which includes a high-pressure mercury lamp, and a reflection mirror that condenses light from the lamp and emits the luminous flux to the front (see JP-A-8-314010). In such a high-pressure mercury lamp, a pair of electrodes are enclosed in a transparent sealed-tube for configuring the mercury lamp, and a lead wire extends to the outside from a root side of each electrode via a metal foil (see JP-A-2005-56599). Here, the electrodes and the metal foil are typically hermetically fixed by shrink seal using thermal shrink of the end portion of the sealed tube.

However, in the high-pressure mercury lamp as above, since the root side of the electrode is fixed to one side of the metal foil, a layout tends to be asymmetric with respect to an axis of the electrode, so that the following case frequently occurs: when the electrodes are fixed to both ends of the sealed tube by shrink seals, the electrodes are obliquely fixed with respect to an axis of the sealed tube. In this case, since a position or size of an arc formed between the electrodes of the high-pressure mercury lamp varies for each product, variation occurs in brightness of the lamp, in addition, variation occurs in distribution of temperature, leading to variation in life of the lamp. Moreover, when the position of the arc is significantly deviated, use efficiency of light is reduced, the light being taken in a fly eye optical system for light equalization or the like in a subsequent stage, consequently illuminance of a projected image is significantly reduced in some cases. Furthermore, in the case of a lamp for a projector, while a sub mirror is sometimes provided facing a reflection mirror to return light from the arc to an arc side, when the electrodes are obliquely fixed with respect to the axis of the sealed tube to some extent or more, a light from the sealed tube is hard to be accurately returned to the arc or neighborhood of the arc.

### SUMMARY

An advantage of some aspects of the invention is to provide an arc tube and a light source apparatus being small in variation in brightness or life.

Moreover, another advantage of some aspects of the invention is to provide a projector of high image quality incorporating the arc tube as described above for illumination.

An arc tube according to an aspect of the invention includes at least one conductive member having a lead wire extending to the outside, an electrode extending to the inside, and a metal foil member that is interposed between the lead wire and the electrode, and electrically connects the lead wire to the electrode, and a sealed tube having a body portion that encloses at least a tip portion of the electrode in an internal space, and a fixing portion that fixes at least the metal foil member and a root portion of the electrode of the conductive member in a buried manner, wherein the root portion of the electrode is sandwiched from both sides perpendicular to an axis of the electrode using an end portion of the metal foil member.

In the arc tube, since the electrode is sandwiched from both sides perpendicular to the axis of the electrode using the end portion of the metal foil member in the root side portion, when the metal foil member and the root portion of the electrode are fixed in the fixing portion in a buried manner using shrink seal or the like in order to manufacture the arc tube, a possibility that the electrode is fixed with being inclined with respect to an axis of the sealed tube can be reduced. Thus, a position or size of an arc formed in a direction to a tip of the electrode can be prevented from varying for each product, consequently variation in brightness or life of the arc tube can be reduced.

In another aspect of the invention in the arc tube, the lead wire and the metal foil member of the conductive member extend along the axis of the electrode, and disposed rotationally symmetrically around the axis of the electrode. In this case, stress given to the conductive member can be more balanced, the stress being given when the metal foil member and the root portion of the electrode are buried in the fixing portion, consequently variation in brightness or life of the arc tube can be efficiently reduced.

In a further aspect of the invention, the fixing portion is a small-diameter portion formed at one end or the body portion of the sealed tube formed by enclosing the electrode. In this case, a root of each electrode is fixed in the fixing portion of the arc tube by shrink seal using thermal shrinking, consequently simple and secure fixing and secure airtight can be achieved.

In still another aspect of the invention, the metal foil member has two foil sheets extending approximately parallel to each other along an extending direction of the axis of the electrode, and the two foil sheets hold the end portion of the lead wire and the root portion of the electrode in a manner of sandwiching the portions from opposed directions. In this case, the root portion of the electrode can he held in a manner of being sandwiched from both sides by a simple metal foil member formed by simply arranging the two foil sheets, consequently the electrode is stably held.

In still another aspect of the invention, the metal foil member comprises a body portion, and an end portion that is connected to one end of the body portion, and has first and second portions extending approximately parallel to each other approximately along an extending direction of the axis of the electrode, and the first and second portions hold the root portion of the electrode in a manner of sandwiching the portion from opposed directions. In this case, the root portion of the electrode can be held in a manner of being sandwiched from both sides by a simple metal foil member formed by laminating two foil sheets at the end portion, consequently the electrode is stably held.

In still another aspect of the invention, the end portion of the metal foil member has first and second portions formed by cutting an end portion of one foil sheet in two approximately along an extending direction or the axis of the electrode, and the first and second portions hold the root portion of the electrode in a manner of sandwiching the portion from opposed directions. In this case, the root portion of the electrode can be held in a manner of being sandwiched from both sides by a metal foil member by simply cutting the end portion of one foil sheet into an appropriated shaper consequently the electrode is stably held.

A light source apparatus according to an aspect of the invention has the arc tube having a couple of the conductive members, and the sealed tube having first and second fixing portions provided at both sides of the body portion correspondingly to the respective conductive members, and a main reflection mirror that is provided at a side of the first fixing portion of the arc tube, and emits light radiated from the arc tube while arranging the light in a predetermined direction.

In the light source apparatus, since the electrode of the arc tube is sandwiched in the root portion of the electrode from both sides perpendicular to the axis of the electrode using the end portion of the metal foil member, when the metal foil member and the root portion of the electrode are fixed in the fixing portion in a buried manner, a possibility that the electrode is fixed with being inclined with respect to an axis of t sealed tube can be reduced. Thus, a position or size of an arc formed in a direction to a tip of the electrode can be prevented from varying for each product, consequently variation can be reduced in brightness or life of the light source apparatus having the arc tube.

In another aspect of the invention, the light source apparatus further includes a sub reflection mirror that is provided at a side of the second fixing portion of the arc tube, and returns light, which are radiated from the arc tube to a side opposite to the main refection mirror, to an emission section in the body portion of the arc tube. In this case, since light emitted to the front of the arc tube can be collected and led to the main reflection mirror, use efficiency of light can be more improved.

A projector according to an aspect of the invention includes the light source apparatus, a light modulating section that modulates the luminous flux emitted from the light source apparatus according to inputted image information to form modulated light, and a projection optical system that projects the modulated light from the light modulating section as image light.

In the projector, the modulated light formed by the light modulation device can be projected to a screen or the like as image light. At that time, since a light source apparatus being small in variation in brightness or life is used as a light source apparatus, an inexpensive projector that can project a bright, clear image can be provided.

In another aspect of the invention, in the projector light source apparatus, the light modulating section has light modulate devices for respective colors that modulate light of respective colors; and a color separation optical system that separates luminous flux emitted from the light source apparatus into light of respective colors, and guides the light to the light modulating devices for respective colors, and a color synthetic optical system that synthesizes modulated light of respective colors modulated by the light modulating devices for respective colors are further provided; and the projection optical system projects image light synthesized by the color synthetic optical system. In this case, a color image obtained by synthesizing modulated light of respective colors formed by a plurality of light modulation sections can be projected.

### BRIEF DESCRIPTION OF THE DRAWINGS

The invention will be described with reference to the accompanying drawings wherein like numbers reference like elements.

FIG. 1 is a diagram for explaining an optical system of a light source lamp unit according to a first embodiment.

FIG. 2 is a perspective diagram of the light source lamp unit shown in FIG. 1.

FIG. 3A is a front diagram of a conductive member incorporated in the light source lamp unit.

FIG. 3B is a side diagram of the conductive member incorporated in the light source lamp unit.

FIG. 4 is a diagram for explaining a method of manufacturing a lamp body of the light source lamp unit.

FIG. 5A is a diagram for explaining a lamp body in a second embodiment.

FIG. 5B is a diagram for explaining the lamp body in the second embodiment.

FIG. 6A is a diagram for explaining a lamp body in a third embodiment.

FIG. 6B is a diagram for explaining the lamp body in the third embodiment.

FIG. 7 is a diagram for explaining a modification of the lamp body in the third embodiment.

FIG. 8A is a diagram for explaining a lamp body in a fourth embodiment.

FIG. 8B is a diagram for explaining the lamp body in the fourth embodiment.

FIG. 9A is a diagram for explaining a lamp body in a fifth embodiment.

FIG. 9B is a diagram for explaining the lamp body in the fifth embodiment.

FIG. 10 is a diagram for explaining an optical system of a projector according to a sixth embodiment.

### DESCRIPTION OF EXEMPLARY EMBODIMENTS

### First Embodiment

Hereinafter, a light source lamp unit as a light source apparatus according to a first embodiment of the invention will be described according to drawings.

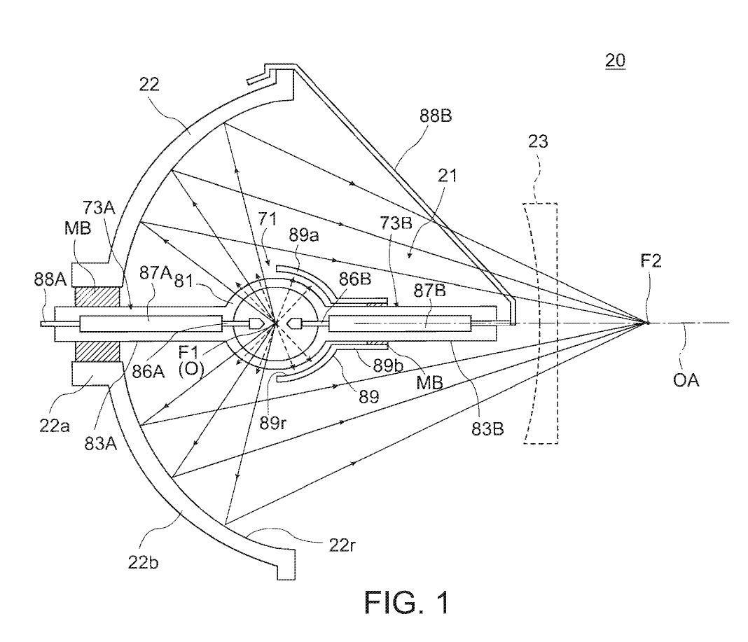

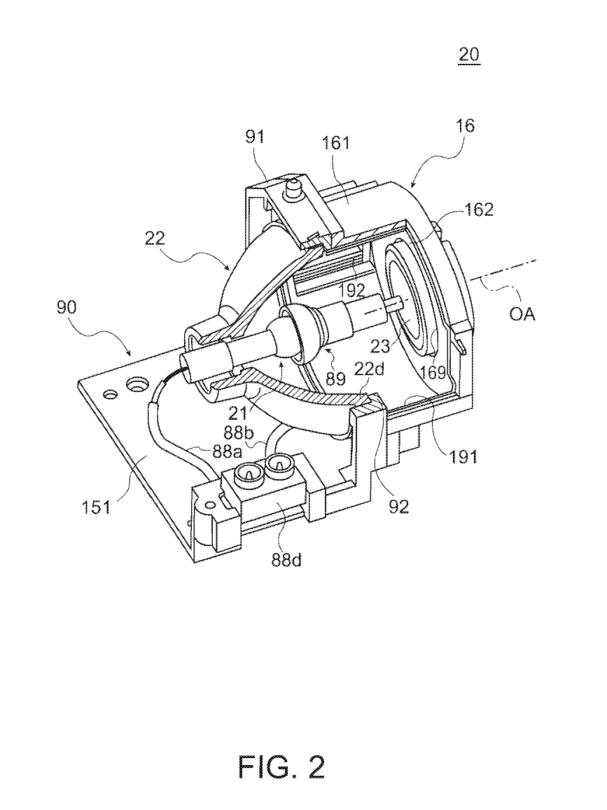

FIG. 1 is a side section diagram of a light source lamp unit 20, and FIG. 2 is a perspective diagram of the light source lamp unit 20. The light source lamp unit 20 is a light source apparatus having a lamp body 21 which in an arc tube, concave mirror 22 being an elliptic reflector, sub reflector 89 being a spherical reflector, and concave lens 23. In the light source lamp unit 20, the lamp body 21 is a discharge-type arc tube for radiating light-source light, which is supported at one end by the concave mirror 22 as a main reflector, and integrated with the concave mirror 22 so that a lamp assembly is configured. The concave mirror 22 and the concave lens 23 are fixed with being aligned with a holder shown in FIG. 2.

The lamp body 21 has a sealed tube 71, first conductive member 73A, and second conductive member 73B. Here, the sealed tube 71 includes a transparent quartz glass tube having a central portion being spherically expanded, and the central portion is formed as a emission section 81 corresponding to a body portion. Both end portions, which are provided at sides opposite to each other with the light emitting section 81 between them, are formed as first and second fixed sections 83A, 83B corresponding to a pair of small-diameter sections. The first conductive member 73A at a side of the first fixed section 83A has a tungsten electrode 86A, a first metal foil member 87A made of molybdenum, and a lead wire 88A made of molybdenum. The second conductive member 73B has a similar structure as the first conductive member 73A, and has an electrode 86B, a second metal foil member 87B, and a lead wire 88B.

In the sealed tube 71, gas, which contains mercury, noble gas, halogen and the like, is enclosed in a spherical internal space in the emission section 81 to achieve a desired emission characteristic correspondingly to an emission type of the lamp body 21. End portions of the pair of electrodes 86A, 86B extend into the internal space from both ends of the emission section 81, that is, sides of the first and second fixed sections 83A, 83B. When power supply is connected to the first and second conductive members 73A, 73B, arc discharge occurs between both electrodes 86A, 86B, and the inside of the emission section 81 emits light with high luminance, so that light-source beams are emitted to the periphery.

In the first fixed section 83A of the lamp body 21, a root portion of the electrode 86A, the first metal foil member 87A, and an end portion of the lead wire 88A are hermetically fixed by shrink seal using thermal shrinking of the quartz glass tube. In the second fixed section 83B, a root portion or the electrode 86B, the second metal foil member 87B, and an end portion of the lead wire 88B are hermetically fixed by shrink seal using thermal shrinking of the quartz glass tube.

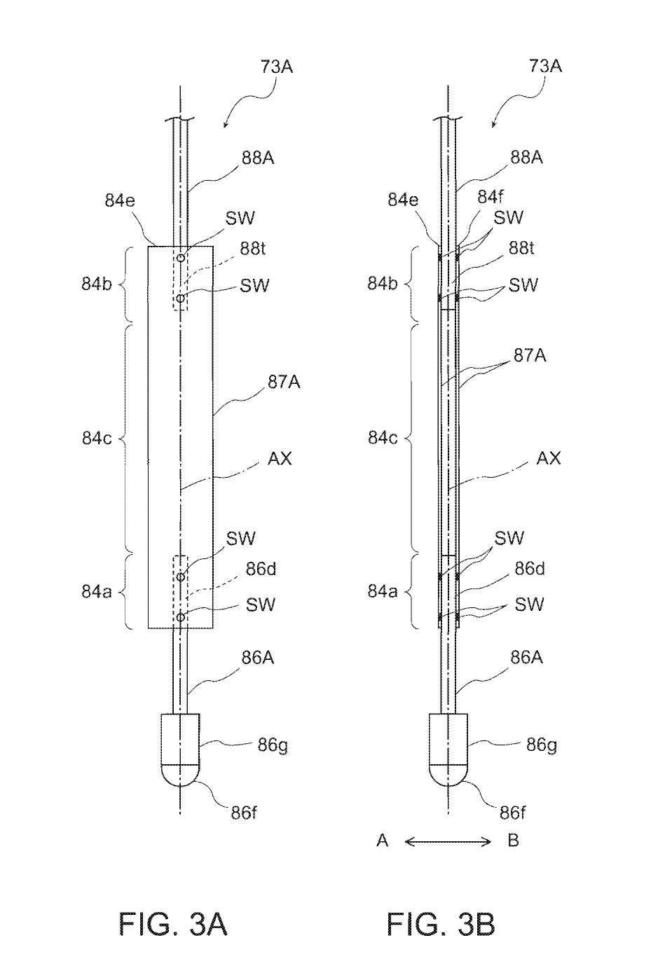

FIG. 3A and FIG. 3B are a plane diagram and a side diagram for explaining a structure of the first conductive member 73A respectively. In the first conductive member 73A, the first metal foil member 87A includes two foil sheets 84e, 84f which are disposed parallel to each other along an electrode axis AX. At a tip of the electrode 86A fixed to a tip (lower end on paper) of the first metal foil member 87A, an electrode tip section 86f having a semispherical or hosta-like outline is formed, and a coil 86g or the like is wound on a root portion of the tip section 86f.

The first metal foil member 87A has an electrode attachment 84a for attaching the electrode 86A, a lead wire attachment section 84b for attaching the lead wire 88A, and a body section 84c provided between both the attachment sections 84a and 84b. In the electrode attachment section 84a, a root portion 86d configuring the electrode 86A, which has a circular section and is in a rod shape, is fixed by being sandwiched from directions of opposed side faces by part of two foil sheets 84e and 84f. That is, the root portion 86d of the electrode 86A is sandwiched from both sides along an AB direction perpendicular to the electrode axis AX. At that time, in aside of one foil sheet 84e, for example, fixing portions SW are formed at two points using spot welding or the like, and in a side of the other foil sheet 84f, for example, fixing portions SW are formed at two points using spot welding or the like. In this way, the root portion 86d of the electrode 86A is fixed by being sandwiched by the two foil sheets 84e and 84f, thereby the electrode 86A and the electrode attachment section 84a are disposed rotationally symmetrically around the electrode axis AX of the first conductive member 73A along the electrode axis AX, and the electrode 86A is stably fixed in the electrode attachment section 84a. As a result, the electrode 86A can be prevented from being inclined with respect to the electrode axis AX with the first metal foil member 87A or the lead wire 88A as reference during sealing by shrink seal, and therefore a position or size of an arc formed in a direction to the tip of the electrode 86A can be prevented from varying for each product, consequently variation in brightness or life of the lamp body 21 can be reduced.

In the lead wire attachment section 84b, an end portion 88t configuring the lead wire 88A, which has a circular section and is in a rod shape, is also fixed by being sandwiched from directions of opposed side faces by parts of two foil sheets 84e and 84f. That is, the end portion 88t of the lead wire 88A is sandwiched from both sides along the AB direction perpendicular to the electrode axis AX. At that time, in a side of one foil sheet 84e, for example, fixing portions SW are formed at two points using spot welding or the like, and in a side of the other foil sheet 84f, for example, fixing portions SW are formed at two points using spot welding or the like. In this way, the end portion 88t of the lead wire 88A is fixed by being sandwiched by the two foil sheets 84e and 84f, thereby the lead wire 88A is disposed rotationally symmetrically around the electrode axis AX of the first conductive member 73A along the electrode axis AX, and the lead wire 88A is stably fixed in the lead wire attachment section 84b. As a result, the first metal foil member 87A oar the electrode 86A can be prevented from being inclined with respect to the electrode axis AX with the lead wire 88A as a reference during sealing by shrink seal, and therefore a position or size of an arc formed in a direction to the tip of the electrode 86A can be prevented from varying for each product, consequently variation in brightness or life of the lamp body 21 can be reduced.

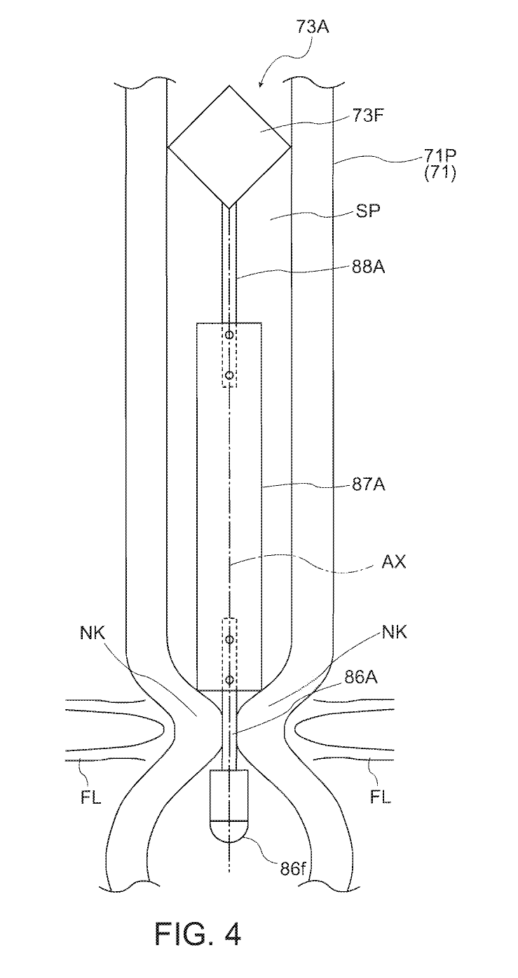

FIG. 4 is a diagram for explaining a shrink seal step for fixing the first metal foil member 87A in the sealed tube 71. The first metal foil member 87A is held in an in-tube space SP of a preform 71P of the sealed tube 71. At that time, a fixture 73F is temporarily connected to an upper end portion of the lead wire 88A, so that the preform can be hung in a condition that the electrode axis AX is aligned with an axis of the in-tube space SP. In this condition, flame FL from a burner is supplied to an appropriate place in a lower part of the preform 71P, thereby a neck portion NK is formed in the preform 71P, and a root side of the electrode 86A is fixed to the neck portion NK. Thus, the electrode 86A is fixed to the axis of the in-tube space SP, so that adhesion of the electrode 86A with the neck portion NK (sealing of the sealed tube 71) is achieved. Then, a point to which the flame FL is contacted is gradually raised, thereby an upper part of the preform 71P is generally reduced in size so that the root portion of the electrode 86A, the first metal foil member 87A, and the lead wire 88A are fixed along the axis of the in-tube space SP, consequently the first fixed section 83A (see FIG. 1) is formed. At that time, as described before, the electrode 86A or the lead wire 88A is stably fixed to the first metal foil member 87A, and the electrode 86A can be fixed to the preform 71P or an axis of the emission section on 81 while being accurately positioned on the axis.

Since a structure, manufacturing, assembly and the like of the first metal foil member 87A as described hereinbefore are the same as those of the second metal foil member 87B, description on those of the second metal foil member 87B is omitted. As a result, similarly in the second metal foil member 87B, the second metal foil member 87B or the electrode 86B can be prevented from being inclined with respect to the electrode axis AX with the lead wire 88B as a reference during sealing by shrink seal, and therefore a position or size of an arc formed in a direction to the tip of the electrode 86B can be prevented from varying for each product, consequently variation in brightness or life of the lamp body 21 can be reduced.

Returning to FIG. 1, a front side of emitting light from the emission section 81 of the lamp body 21, the front side being corresponding to approximately half the section 81, is covered with a sub reflection mirror 89. The sub reflection mirror 89 includes a sub reflection section 89a that returns light radiated forwardly from the emission section 81 of the lamp body 21 to the emission section 81, and a support section 89b fixed to the periphery of the second fixed section 83B while supporting a root portion of the sub reflection mirror section 89a. Here, an inside glass surface of the sub reflection section 89a is processed in a concave curved surface shape being approximately spherical in accordance with a surface of the emission section 81, and a reflective surface 89b is formed on the glass surface. The support section 89b is inserted with the second fixed section 83B in the center thereof, and allows the sub reflection section 89a to be fixed to the emission section 81 with being aligned with the emission section 81 by filling an inorganic adhesive MB into a cap with respect to the second fixed section 83B.

The concave mirror 22 is integral molding made of quartz glass having a neck section 22a inserted with the first fixed section 83A of the lamp body 21, and a main reflection section 22b in an elliptic curved surface shape spreading from the neck section 22a. The neck section 22a is inserted with the first fixed section 83A, and allows the main reflection section 22b to be fixed to the emission section 81 with being aligned with the emission section 81 by filling the inorganic adhesive MB into a gap with respect to the first fixed section 83A. An inside glass surface of the main reflection section 22b is processed in an approximately elliptic, curved surface shape, and a reflective surface 22r is formed on the inside glass surface.

The lamp body 21 is disposed along a system light axis OA corresponding to a light axis of the main reflection section 22b, and disposed such that an emission center O between the electrodes 86A and 86B in the emission section 81 corresponds to a position of the first focal point F1 of the elliptic curved surface of the main reflection section 22b. When the lamp body 21 is turned on, light radiated from the emission section 81 are reflected by the main reflection section 22b, or reflected by the main reflection section 22b via the sub reflection mirror 89, and then formed into a luminous flux that converge into a second focal point F2 of the elliptic curved surface.

Referring to FIG. 2, the light source lamp, unit 20 includes the lamp body 21, concave mirror 22, sub reflection mirror 89, and concave lens 23, in addition, a holding member 16 for holding the concave lens 23, and an inner holder 90 for holding the concave mirror 22.

The inner holder 90 is integral molding made of synthetic resin having an L-shaped section, and includes a horizontal section 151 and a frame section 91. The horizontal section 151 is engaged with a wall portion of a case 11 (not shown) for incorporating the light source lamp unit 20. The horizontal section 151 is fixed with a connector 88d for electrically connecting the lamp body 21 to an external power supply, and the connector 88d is connected with two wire cables 88a and 88b extending from the lead wires 88A and 88B of the lamp body 21 respectively.

The frame section 91 has a rectangular, cylindrical shape, and includes a stopper 92 to be connected with a light emitting opening edge of the concave mirror 22 so as to perform positioning in a direction of the system light axis (illumination light axis) OA. A peripheral edge portion 22d as the light emitting opening edge of the concave mirror 22 is pressed and fixed to the frame section 91 by a holding spring (not shown). Moreover, projections and concave portions are formed in place in such horizontal section 151 and frame section 91, and the projections/concave portions are engaged with concave portions/projections formed in an optical apparatus incorporating the light source lamp unit 20 respectively, thereby the light axis of the concave mirror 22 or the illuminating light axis is aligned with the system light axis OA of the optical apparatus, so that the emission center O of the lamp body 21 is disposed on the system light axis OA.

The holding member 16, which has a cylindrical shape in accordance with a light emitting opening of the concave mirror 22, is fixed by adhesion to the frame section 91 from a side opposite to the concave mirror 22, and holds a peripheral end portion of the concave 23. The holding member 16 includes a cylinder section 161 and a holding section 162 being integrally molded. The cylinder section 161 shades the lamp body 21 within the section 161. The holding section 162 is provided so as to close an end face at a light emitting side of the cylinder section 161, and has an opening 169 to be fitted with the concave lens 23. In the holding member 16, an inlet 191 is formed in one side race of the cylinder section 161 of the holding member 16, and an outlet 192 is formed in the other side face in a manner of being cut into a rectangular shape respectively. Thus, a cooling flow channel can be secured, the channel passing through spaces within the holding member 16 and the concave mirror 22. The inlet 191 and the outlet 192 have meshes (not shown) to prevent scattering or broken pieces of the lamp during bursting of the lamp body 21.

### Second Embodiment

A light source unit of the embodiment is a modification of the light source lamp unit 20 of the first embodiment shown in FIG. 1, wherein portions being not particularly described have the same structures as in the light source lamp unit 20 of the first embodiment, and portions common to the first embodiment are marked with the same references and omitted to be described repeatedly.

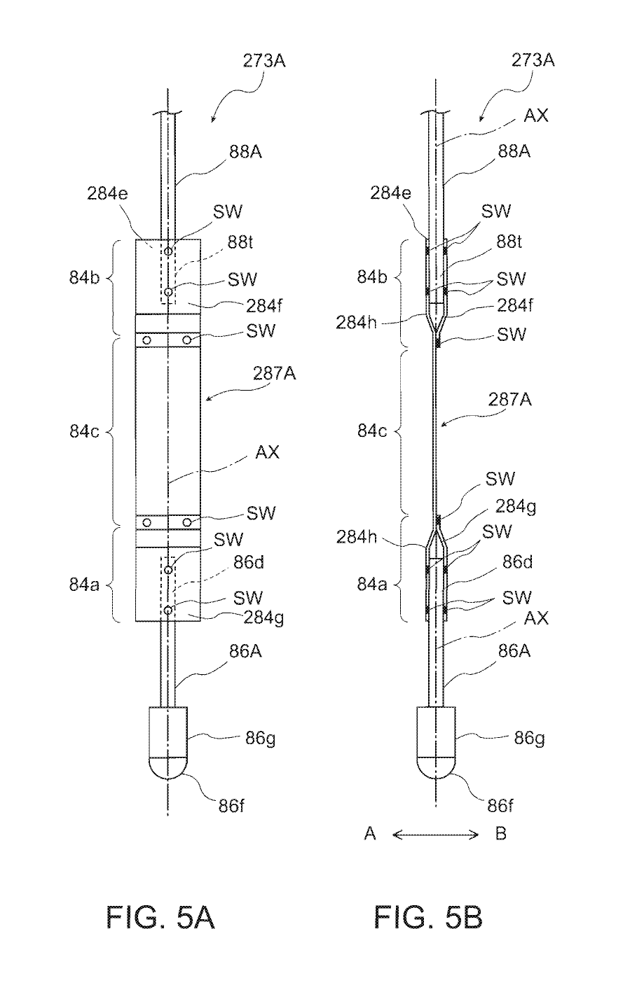

FIGS. 5A and 5B are diagrams for explaining relevant portions of the light source lamp unit according to a second embodiment, a plane digram and a side diagram for explaining a structure of a first conductive member 273A incorporated in the light source lamp unit respectively.

In the first conductive member 273A, a first metal foil member 287A includes one large foil sheet 284e and two small foil sheets 284f and 284g, and is formed by fixing the foil sheets 284f and 284g to both ends of the foil sheet 284e by a plurality of fixing portions SW using spot welding or the like. The foil sheets 284f and 284g are disposed parallel to each other along the electrode axis AX with both end portions 284h, 284h of the foil sheet 284e respectively. Thus, in the electrode attachment section (end portion) 84a, the root portion 86d of the electrode 86A is fixed by being sandwiched from directions of opposed side faces by the foil sheet 284g and the end portion 284h. That is, the root portion 86d of the electrode 86A is sandwiched from both sides along the AB direction perpendicular to the electrode axis AX. In this way, the root portion 86d of the electrode 86A is fixed by being sandwiched by the foil sheet 284g and the end portion 284h, thereby the electrode 86A and the electrode attachment section 84a are disposed rotationally symmetrically around the electrode axis AX of the first conductive member 273A along the electrode axis AX, and the electrode 86A is stably fixed in the electrode attachment section 84a. As a result, the electrode 86A can be prevented from being inclined with respect to the electrode axis AX with the first metal foil member 287A or the lead wire 88A as a reference during sealing by shrink seal.

In the lead wire attachment section (end portion) 84b, the end portio 88t of the lead wire 88A is fixed by being sandwiched from directions of opposed side faces by the foil sheet 284f and the end portion 284h. That is, the end portion 88t of the lead wire 88A is sandwiched from both sides along the AB direction perpendicular to the electrode axis AX. In this way, the end portion 88t of the lead wire 88A is fixed by being sandwiched by the foil sheet 284f and the end portion 284h, thereby the lead wire 88A is disposed rotationally symmetrically around the electrode axis AX of the first conductive member 273A along the electrode axis AX, and the lead wire 88A is stably fixed in the lead wire attachment section 84b. As a result, the first metal foil member 287A or the electrode 86A can be prevented from being inclined with respect to the electrode axis AX with the lead wire 88A as a reference during sealing by shrink seal.

The structure and the like of first metal foil member 287A as described above are similarly applied to the second conductive member 73B in FIG. 1.

### Third Embodiment

An light source lamp unit of the embodiment is a modification of the light source lamp unit 20 of the first embodiment shown in FIG. 1, and portions being not particularly described have the same structures as in the light source lamp unit 20 of the first embodiment.

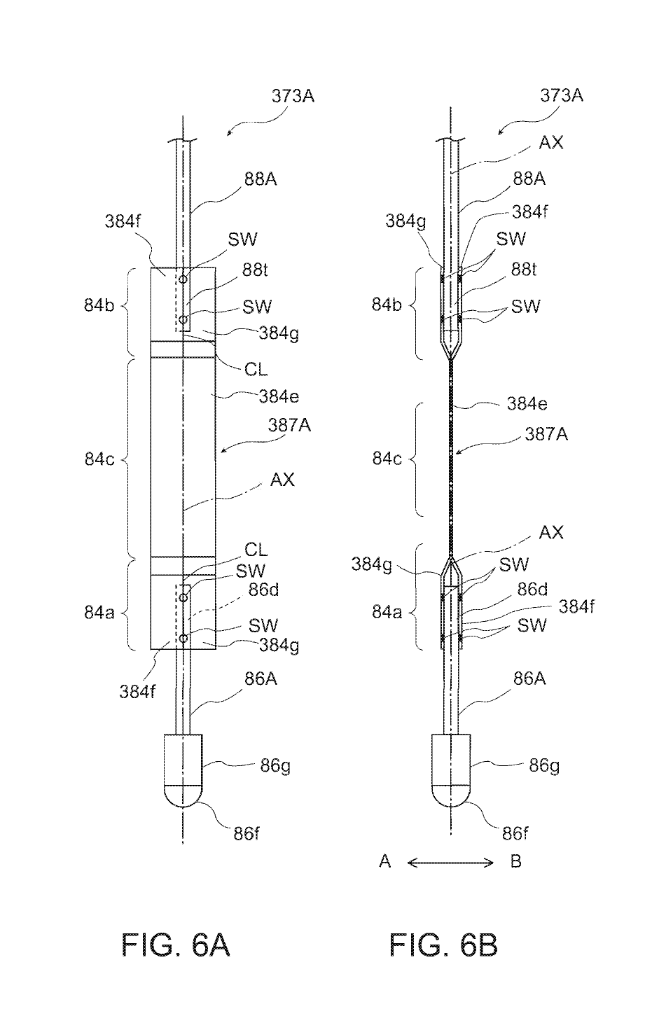

FIGS. 6A and 6B are diagrams for explaining relevant portions of the light source lamp unit according to a third embodiment, and a plane diagram and a side diagram for explaining a structure of a first conductive member 373A incorporated in the light source lamp unit respectively.

In the first conductive member 373A, a first metal foil member 387A includes only one large foil sheet 384e. The foil sheet 384e is a portion corresponding to the electrode attachment section 84a and the lead wire attachment section 84b of the first metal foil member 387A, and has cut lines CL along the electrode axis AX. As a result, the foil sheet 384e is divided into a first portion 384f and a second portion 384g, which extend along the electrode axis AX, at a place of the electrode attachment section 84a. In a front side as shown in FIG. 6A, the first portion 384f is fixed to the root portion 86d of the electrode 86A by a plurality of fixing portions SW using spot welding. In a back side as shown in FIG. 6B, the second portion 384g is fixed to the root portion 86d of the electrode 86A by a plurality of fixing portions SW using spot welding. At that time, the root portion 86d of the electrode 86A is fixed by being sandwiched from directions of opposed side faces by the first and second portions 384f and 384g. That is, the root portion 86d of the electrode 86A is sandwiched from both sides along the AB direction perpendicular to the electrode axis AX. In this way, the root portion 86d of the electrode 86A is fixed by being sandwiched by the two-forked portions 384f, 384c in the end portion of the foil sheet 384e, thereby the electrode 86A or the electrode attachment section 84a is disposed rotationally symmetrically around the electrode axis AX of the first conductive member 373A along the electrode axis AX, and the electrode 86A is stably fixed in the electrode attachment section 84a. As a result, the electrode 86A can be prevented from being inclined with respect to the electrode axis AX with the first metal foil member 387A or the lead wire 88A as a reference during sealing by shrink seal.

Similarly, the foil sheet 384e is divided into the first portion 384f and the second portion 384g, which extend along the electrode axis AX, at a place of the lead wire attachment section 84b. In a front side as shown in FIG. 6A, the first portion 384f is fixed to the end portion 88t of the lead wire 88A by a plurality of fixing portions SW using spot welding. In a back side as shown in FIG. 6B, the second portion 384g is fixed to the end portion 88t of the lead wire 88A by a plurality of fixing portions SW using spot welding. At that time, the end portion 88t of the lead wire 88A is fixed by being sandwiched from directions of opposed side faces by the first and second portions 384f and 384g. That is, the end portion 88t of the lead wire 88A is sandwiched from both sides along the AB direction perpendicular to the electrode axis AXE. In this way, the end portion 88t of the lead wire 88A is fixed by being sandwiched by the two-forked portions 384f, 384g in the end portion of the foil sheet 384e, thereby the lead wire 88A is disposed rotationally symmetrically around the electrode axis AX of the first conductive member 373A along the electrode axis AX, and the lead wire 88A is stably fixed in the lead wire attachment section 84b. As a result, the first metal foil member 387A or the electrode 86A can be prevented from being inclined with respect to the electrode axis AX with the lead wire 88A as a reference during sealing by shrink seal.

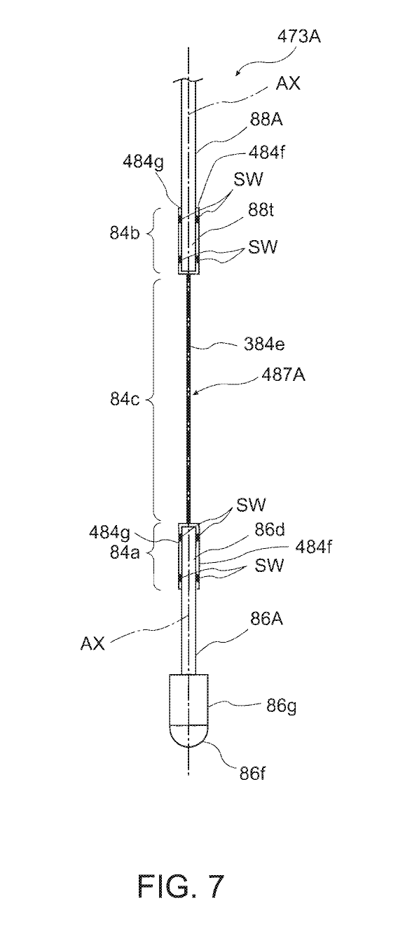

FIG. 7 is a side diagram for explaining a modification of the first conductive member 373A shown in FIGS. 6A and 6B. In this case, in a first conductive member 473A, first and second portions 484f, 484g, which are formed by cutting in both ends of a foil sheet 384e of the first metal foil member 487A, are bent into a hook in base portions near end faces of the root portion 86d and the end portion 88t respectively.

The structure and the like of first metal foil members 387A or 487A as described above are similarly applied to the second conductive member 73B in FIG. 1.

### Fourth Embodiment

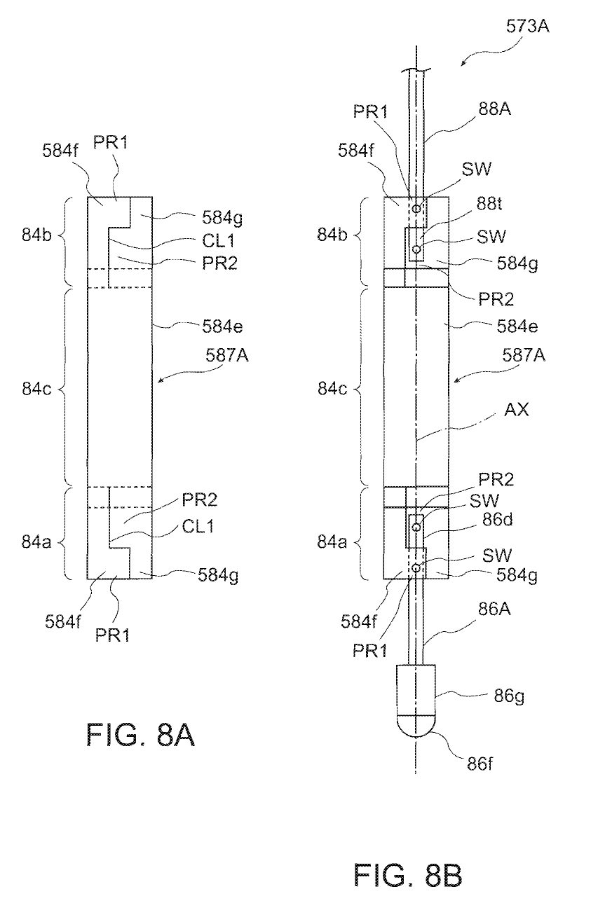

FIG. 8A and FIG. 8B are plane diagrams for explaining a structure of a first conductive member 573A of the embodiment. In the first conductive member 573A, a first metal foil member 587A is formed by modifying the first metal foil member 387A in the third embodiment shown in FIGS. 6A and 6B.

As shown in FIG. 8A, the first metal foil member 587A configuring the first conductive member 573A is formed by only one large foil sheet 584e. The foil sheet 584e has a hook-like cut line CL1 at one end portion corresponding to the electrode attachment section 84a, and divided into a first portion 584f and a second portion 584g, the portions extending approximately along the electrode axis AX. Similarly, the foil sheet 584e has a hook-like cut line CL1 at the other end portion corresponding to the lead wire attachment section 84b, and divided Into a first portion 584f and a second portion 584g, the portions extending approximately along the electrode axis AX.

As shown in FIG. 8B, in a surface side of the electrode attachment section 84a, a first projection PR1 of the first portion 584f is fixed to the root portion 86d of the electrode 86A by a plurality of fixing portions SW using spot welding or the like. Moreover, in a back side, a second projection PR2 of the second portion 584g is fixed to the root portion 86d of the electrode 86A by similar fixing portions (not shown). As a result, the root portion 86d of the electrode 86A is fixed by being sandwiched from directions of opposed side faces by the first and second portions 584f and 584g. Thus, the electrode 86A or the electrode attachment section 84a is disposed symmetrically around the electrode axis AX of the first conductive member 573A along the electrode axis AX, and the electrode 86A is stably fixed in the electrode attachment section 84a.

In a surface side of the lead wire attachment section 84b, a first project PR1 of the first portion 584f is fixed to the end portion 88t of the lead wire 88A by a plurality of fixing portions SW. Moreover, in a back side, a second projection PR2 of the second portion 584g is fixed to the end portion 88t of the lead wire 88A by similar fixing portions (not shown). As a result, the end portion 88t of the lead wire 88A is fixed by being sandwiched from directions of opposed side faces by the first and second portions 584f and 584g. Thus, the lead wire 88A is disposed symmetrically around the electrode axis AX of the first conductive member 573A along the electrode axis AX, and the lead wire 88A, is stably fixed in the lead wire attachment section 84b.

The structure and the like of first metal foil member 587A or the first conductive member 573A as described above are similarly applied to the second metal foil member 87B in FIG. 1.

### Fifth Embodiment

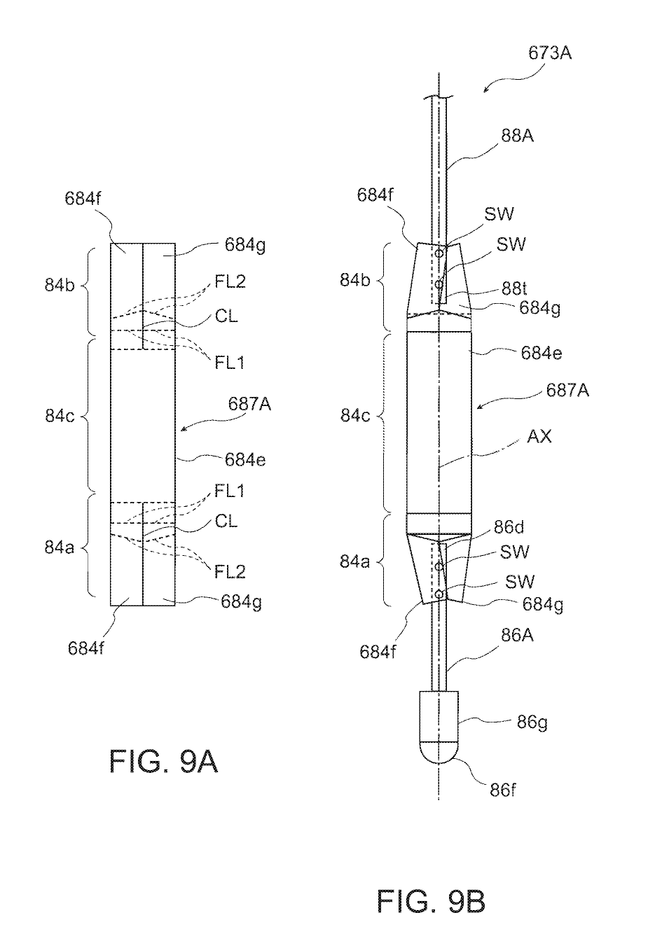

FIG. 9A and FIG. 9B are plane diagrams for explaining a structure of a first conductive member 673A of the embodiment. In the first conductive member 673A, a first metal foil member 687A is formed by modifying the first metal foil member 387A in the third embodiment shown in FIGS. 6A and 6B.

As shown in FIGS. 9A, the first metal foil member 687A configuring the first conductive member 673A is formed by only one large foil sheet 684e. The foil sheet 684e has a cut line CL, which extends parallel to the electrode axis AX, at one end portion corresponding to the electrode attachment section 84a, and is divided into a first portion 684f and a second portion 684g, the portions extending approximately along the electrode axis AX. In respective portions 684f and 684g of the electrode attachment section 84a, broken lines FL1 and FL2 for folding are formed. Similarly, the foil sheet 684e has a cut line CL, which extends parallel to the electrode axis AX, at the other end portion corresponding to the lead wire attachment section 84b, and is divided into a first portion 684f and a second portion 684g, the portions extending approximately along the electrode axis AX. In respective portions 684f and 684g of the lead wire attachment section 84b, broken lines FL1 and FL2 for folding are formed.

As shown in FIG. 9B, in a surface side of the electrode attachment section 84a, the first portion 684f is subjected to mountain fold and valley fold using the broken lines FL1 and FL2, and a tip side of the first portion 684f is protruded to an opposite side and superimposed on the root portion 86d of the electrode 86A. In this condition, the first portion 684f is fixed to the root portion 86d of the electrode 86A by a plurality of fixing portions SW using spot welding or the like. Similarly in the back side, the second portion 684g is fixed to the root portion 86d of the electrode 86A by the same method. As a result, the root portion 86d of the electrode 86A is fixed by being sandwiched from directions of opposed side faces by the first and second portions 684f and 684g. Thus, the electrode 86A or the electrode attachment section 84a is disposed rotationally symmetrically around the electrode axis AX of the first conductive member 673A along the electrode axis AX, and the electrode 86A is stably fixed in the electrode attachment section 84a.

In a surface side of the lead wire attachment section 84b, the first portion 684f is subjected to mountain fold and valley fold using the broken lines FL1 and FL2, and a tip side of the first portion 684f is protruded to an opposite side and superimposed on the end portion 88t of the lead wire 88A. In this condition, the first portion 684f is fixed to the end portion 88t of the lead wire 88A by a plurality of fixing portions SW. Similarly in the back sides, the second portion 684g is fixed to the end portion 88t of the lead wire 88A by the same method. As a result, the end portion 88t of the lead wire 88A is fixed by being sandwiched from directions of opposed side faces by the first and second portions 684f and 684g. Thus, the lead wire 88A is disposed rotationally symmetrically around the electrode axis AX of the first conductive member 673A along the electrode axis AX, and the lead wire 88A is stably fixed in the lead wire attachment section 84b.

The structure and the like of first metal foil member 687A or the first conductive member 673A as described above are similarly applied to the second metal foil member 87B in FIG. 1.

### Sixth Embodiment

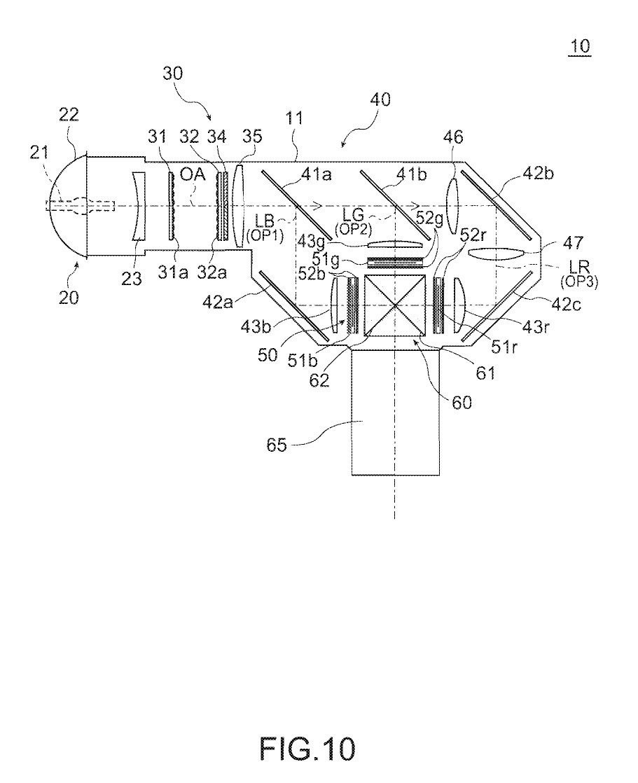

FIG. 10 is a schematic diagram showing an optical system of a projector 10 according to a sixth embodiment of the invention. The projector 10 incorporates a light source lamp unit 20 having the conductive member described in the first to fifth embodiments. The projector 10 is optical equipment that modulates light emitted from a light source according to image information to form an optical image, and projects the optical image onto a screen in an enlarged manner, and includes a light source lamp unit 20, an illumination optical system 30, a color separation device 40, a light modulation section 50, a cross dichroic prism 60, and a projection optical system 65. These optical elements 20, 30, 40, 50, 60 and 65 are fixed in place within a light shielding case 11, or mounted on part of the case 11 from the outside.

The light source lamp unit 20 is a light source apparatus that collects light radiated from a lamp body 21 to the periphery, and emits the light for illuminating the light modulation section 50 via the illumination optical system 30 and the color separation device 40. As the light source lamp unit 20, any of the light source lamp units 20 described in the first to sixth embodiments can he used without any modification, and the lamp unit 20 includes the lamp body 21, concave mirror 22, and concave lens 23. In the light source lamp units 20, light source light emitted from the lamp body 21 is collimated via the concave mirror 22 and the concave lens 23, then emitted to a front side, that is, a side of the illumination optical system 30.

The illumination optical system 30 is an optical system that splits a luminous flux emitted from the light source lamp units 20 into a plurality of partial luminous fluxes, and emits the plurality of luminous fluxes into an illumination area as an project in an superimposed manner, so that in-plane illuminance of the illumination area is equalized, and has a first lens array 31, second lens array 32, polarization conversion member 34, and condenser lens 35.

The first lens array 31 has a function of a light splitter optical element that splits the luminous flux emitted from the lamp body 21, into a plurality of partial luminous fluxes, and includes a plurality of small lenses 31a arranged in a matrix pattern in a plane perpendicular to the system light axis OA. A profile of each small lens 31a is set so as to be approximately similar to a shape of an image formation region of each of liquid crystal panels 51b, 51g and 51r configuring the light modulation section 50 as described later. The second lens array 32 is an optical element for condensing the plurality of partial luminous fluxes split by the first lens array 31, and includes a plurality of small lenses 32a arranged in a matrix pattern in a plane perpendicular to the system light axis OA as the first lens array 31. However, since the second lens array 32 is for light condensation, a profile of each small lens 32a need not correspond to the shape of the image formation region of each of the liquid crystal panels 51b, 51g, and 51r.

The polarization conversion member 34 is formed by a PBS arras and a phase difference plate, and serves to arrange polarization directions of the respective partial luminous fluxes split by the first lens arras in unidirectional linear polarization. While being omitted to be shown in detail, the PBS array of the polarization conversion member 34 has a configuration where polarization separation films and reflection mirrors, which are obliquely disposed with respect to the system light axis OA, are alternately arranged. The former, polarization separation film transmits one polarized light between a P-polarized light and an S-polarized light included in each partial light, and reflects the other polarized light. The other polarized light being reflected is bent by the latter, reflection mirror, and emitted in an emitting direction of one polarized light, that is, in a direction along the system light axis OA. Some of the emitted polarized lights are subjected to polarization conversion by the phrase difference plate provided in a stripe pattern on a light emitting surface of the polarization conversion member 34, so that polarization directions of all the polarized light are aligned. Such a polarization conversion member 34 is used thereby light emitted from the lamp body 21 can be arranged in unidirectional polarized light, and therefore utilization factor of light-source light used in the light modulation section 50 can be improved.

The condenser lens 35 is a superimposing optical element that condenses a plurality of partial luminous fluxes via the first lens array 331, second lens array 32, and polarization conversion member 34, and emits the luminous fluxes onto the image formation regions of the liquid crystal panels 51b, 51g and 51r in a superimposed manner. Light emitted from the condenser lens 35 are emitted into the color separation device 40 in a subsequent stage while being equalized. That is, after passing through both the lens arrays 31 and 32 and the condenser lens 35, illumination light passes through the color separation device 40 described in detail below, then the illumination light uniformly illuminates the image formation regions of the light modulation section 50, that is, the liquid crystal panels 51b, 51g and 51r in a superimposed manner.

The color separation device 40 has first and second dichroic mirrors 41a and 41b, reflection mirrors 42a, 42b and 42c, field lenses 43r, 43b and 43g, and a relay optical system 46, 47. Among them, a color separation optical system including the first and second dichroic mirrors 41a and 41b separates the illumination light into three luminous fluxes of blue (B) light, green (G) light, and red (R) light. Each of the dichroic mirrors 41a and 41b is an optical element obtained by forming a dielectric multilayer film on a transparent substrate, the film having a wavelength selection function of reflecting a luminous flux in a predetermined way length range, and transmitting a luminous flux in other wavelength ranges, and disposed while being inclined with respect to the system light axis OA. The first dichroic mirror 41a reflects blue light LB in three colors of red/blue and green (R, G, B), and transmits green light LG and red light LR. The second dichroic mirror 41b reflects green light LG, and transmits red light LR between injected green light LG and red light LR.

In the color separation device 40, illumination light injected from the light source lamp unit 20 via the illumination optical system 30 is first injected into the first dichroic mirror 41a. Blue light LB reflected by the first dichroic mirror 41a led into a first optical path OP1, and then injected into the field lens 43b, in a final stage via the reflection mirror 42a. Green light LG transmitted by the first dichroic mirror 41a and reflected by the second dichroic mirror 41b is led into a second optical path OP2, and then injected into the field lens 43g in a final stage. Furthermore, red light LR transmitted by the second dichroic mirror 41b is led into a third optical path OP3, and then injected into the field lens 43r in a final stage via the reflection mirrors 42b and 42c and the relay optical system 46, 47. The relay optical system 46, 47 transmits an image, which is formed directly before the first lens 46 at an injection side, to the field lens 43r at an light emitting side via the second lens 47 in a subsequent stage with the image being substantially not changed, so that reduction in use efficiency due to light diffusion or the like is prevented.

The light modulation section 50 has the three liquid crystal panels (liquid crystal display panels) 51b, 51g and 51r to which three colors of illumination light LB, LG and LR are injected respectively, and three sets of polarization filters 52b, 52g and 52r disposed so as to sandwich the liquid crystal panels 51b, 51g and 51r respectively. Here, for example, the liquid crystal panel 51b for blue light LB, and a pair of polarization filters 52b, 52b sandwiching the panel 51b configure a liquid crystal light valve for modulating luminance of illumination light two-dimensionally. Similarly, the liquid crystal panel 51g for green light LG and corresponding polarization filters 52g, 52g configure a liquid crystal light valve, and the liquid crystal panel 51r for red light LR and corresponding polarization filters 52r, 52r configure a liquid crystal light valve. Each of the liquid crystal panels 51b, 51g and 51r is formed by hermetically containing liquid crystal being an electro-optical substance between a pair of transparent glass substrates, and for example, modulates a polarization direction of a polarized light emitted into each panel according to a given image signal using polysilicon TFT as a switching element.

In the light modulation section 10, the blue light LB led into the first optical path OP1 is injected into the image formation region of the liquid crystal panel 51b via the field lens 43b. The green light LG led into the second optical path OP2 is injected into the image formation region of the liquid crystal panel 51g via the field lens 43g. The red light LR led into the third optical path OP3 is injected into the image formation region of the liquid crystal panel 51r via the relay optical system 46, 47 and the field lens 43r. Each of the liquid crystal panels 51b, 51g and 51r is a nonradiative and transmissive, light modulating device for changing spatial distribution of a polarization direction of injected illumination light. Each color light LB, LG and LR injected into each of the liquid crystal panels 51b, 51g and 51r is adjusted in polarization condition for each pixel according to a drive signal or control signal inputted into each of the liquid crystal panels 51b, 51g and 51r as an electric signal according to image information. At that time, each of the polarization filters 52b, 52g and 52r adjusts a polarization direction of illumination light injected into each of the liquid crystal panels 51b, 51g and 51r, and extracts modulated light in a predetermined polarization direction from light emitted from each of the liquid crystal panels 51b, 51g and 51r.

The cross dichroic prism 60 is a light synthetic optical system that synthesizes optical images modulated for each color light emitted from polarizing plates at light emitting sides to form a color image. The cross dichroic prism 60 is in an approximately square shape in a plane view, which is formed by adhering four rectangular prisms to one another. In adhesion interfaces between the rectangular prisms, a pair of dielectric multilayer films 61, 62 crossing each other in an X-shape are formed respectively. One of the films, or a first dielectric multilayer film 61 reflects blue light, and the other of the films, or a second dielectric multilayer film 62 reflects red light. The cross dichroic prism 60 reflects the blue light LB from the liquid crystal panel 51b by the first dielectric multilayer film 61 to be emitted to right in a forward direction, reflects the red light LR from the liquid crystal panel 51r by the second dielectric multilayer film 62 to be emitted to left in a forward direction, and allows the green light LG from the liquid crystal panel 51g to be straightly emitted via both the dielectric multilayer films 61 and 62.

Image light synthesized by the cross dichroic prism 60 in this way is projected to a screen (not shown) as a color image in an appropriate scaling factor via a projection optical system 65 as a magnifying projection lens.

While the invention was described according to the embodiments hereinbefore, the invention is not limited to the embodiments. For example, the profile of the metal foil member 87A or 87B is not limited to a rectangle, and can be an appropriate shape of various shapes. Moreover, the shape of the electrode 86B is merely for exemplification, and can be appropriately modified depending on application and the like.

While the first and second conductive members 73A and 73B are in the same structure in the light source lamp unit 20 of the embodiment, for example, the second conductive member 73B can be in a usual types. Again in this case, alignment accuracy can be improved in at least the first conductive member 73A.

In the light source lamp unit 20 of the embodiment, the reflective surfaces 22r and 89r of the concave mirror 22 and the sub reflection mirror 89 are not limited to be the elliptic curved surface and the spherical surface respectively, and can be an appropriate surface of various curved surfaces depending on accuracy or other specifications required for the light source lamp unit 20.

Moreover, while two lens arrays 31 and 32 were used to split light from the light source lamp unit 20 or the like into a plurality of partial luminous fluxes in the projector 10 of the embodiment, the invention can be applied to a projector that does not use such lens arrays 31 and 32. Furthermore, the lens arrays 31 and 32 can be replaced by a rod integrator.

Moreover, while the PBS array, which arranged light from the light source lamp unit 20 or the like in polarized light in a particular direction, was used in the embodiment, the invention can be applied to a projector that does not use such a PBS array.

While an example of the projector 10 using three light modulating devices was described in the embodiment, the invention can be applied to a projector using one light modulating device, or two or at least four light modulating devices.

Moreover, while an example of a case that the invention was applied to the transmissive projector was described in the embodiment, the invention can be applied to a reflective projector. Here, “transmissive” means a type that a light valve including liquid crystal panels or the like transmits light, and “reflective” means a type that the light valve reflects light. In the case of the reflective projector, the light valve can be configured by only the liquid crystal panels, and the pair of polarizing plates are unnecessary. The light modulating device is not limited to the device using the liquid crystal panels, and may be a device using micromirrors.

As the projector, the following projectors are given: a front projector that performs image projection in a direction of observing a projection plane, and a back projector that performs image projection in a direction opposite to the direction of observing the projection plane. The configuration of the projector 10 of FIG. 10 can be applied to either of the projectors.

The entire disclosure of Japanese Patent Application No. 2006-281144, filed Oct. 16, 2006 is expressly incorporated by reference herein.

What is claimed is:

1. An arc tube comprising:
at least one conductive member having
a lead wire extending to the outside,
an electrode extending to the inside, and
a metal foil member that is interposed between the lead wire and the electrode, and electrically connects the lead wire to the electrode; and
a sealed tube having a body portion that encloses at least a tip portion of the electrode in an internal space, and a fixing portion that fixes at least the metal foil member and a root portion of the electrode of the conductive member in a buried manner,
wherein the root portion of the electrode is sandwiched from both sides perpendicular to an axis of the electrode using an end portion of the metal foil member.

2. The arc tube according to claim 1,
wherein the lead wire and the metal foil member of the conductive member extend along the axis of the electrode, and disposed rotationally symmetrically around the axis of the electrode.

3. The arc tube according to claim 1,
wherein the fixing portion is a small-diameter portion formed at one end of the body portion of the sealed tube formed enclosing the electrode.

4. The arc tube according to claim 1,
wherein the metal foil member has two foil sheets extending approximately paralleled to each other along an extending direction of the axis of the electrode, and
the two foil sheets hold the end portion of the lead wire and the root portion of the electrode in a manner of sandwiching the portions from opposed directions.

5. The arc tube according to claim 1,
wherein the metal foil member comprises
a body portion, and
an end portion that is connected to one end of the body portion, and has first and second portions extending approximately parallel to each other approximately along an extending direction of the axis of the electrode, and
the first and second portions hold the root portion of the electrode in a manner of sandwiching the portion from opposed directions.

6. The arc tube according to claim 1,
wherein the end portion of the metal foil member has first and second portions formed by cutting an end portion of one foil sheet in two approximately along an extending direction of the axis of the electrode, and
the first and second portions hold the root portion of the electrode in a manner of sandwiching the portion from opposed directions.

7. A light source apparatus, comprising:
the arc tube according to claim 1, having
a couple of the conductive members, and
the sealed tube having first and second fixing portions provided at both sides of the body portion correspondingly to the respective conductive members, and
a main reflection mirror that is provided at a side of the first fixing portion of the arc tube, and emits light radiated from the arc tube while arranging the light in a predetermined direction.

8. A light source apparatus, further comprising:
a sub reflection mirror that is provided at a side of the second fixing portion oft the arc tube, and returns light, which are radiated from the arc tube to a side opposite to the main reflection mirror, to an emission section in the body portion of the arc tube.

9. The light source apparatus according to claim 8,
wherein the metal foil member has two foil sheets extending approximately parallel to each other along an extending direction of the axis of the electrode, and
the two foil sheets hold the end portion of the lead wire and the root portion of the electrode in a manner of sandwiching the portions from opposed directions.

10. The light source apparatus according to claim 8,
wherein the metal foil member comprises
a body portion, and
an end portion that is connected to one end of the body portion, and has first and second portions extending approximately parallel to each other approximately along an extending direction of the axis of the electrode, and
the first and second portions hold the root portion of the electrode in a manner of sandwiching the portion from opposed directions.

11. The light source apparatus according to claim 8,
wherein the end portion of the metal foil member has first and second portions formed by cutting an end portion of one foil sheet in two approximately along an extending direction of the axis of the electrode, and
the first and second portions hold the root portion of the electrode in a manner of sandwiching the port on from opposed directions.

12. A projector, comprising:
the light source apparatus according to claim 7,
a light modulating section that modulates the luminous flux emitted from the light source apparatus according to inputted image information to form modulated light, and
a protection optical system that projects the modulated light from the light modulating section as image light.

13. The projection according to claim 12,
wherein the light modulating section has light modulating devices for respective colors that modulate light of respective colors, and
a color separation optical system that separates a luminous flux emitted from the light source apparatus into light of respective colors, and guides the light to the light modulating devices for respective colors, and
a color synthetic optical system that synthesizes modulated light of respective colors modulated by the light modulating devices for respective colors are further provided, and
the projection optical system projects image light synthesized by the color synthetic optical system.

14. The projector according to claim 12,
wherein the metal foil member has two foil sheets extending approximately parallel to each other along an extending direction of the axis of the electrode, and
the two foil sheets hold the end portion of the lead wire and the root portion of the electrode in a manner of sandwiching the portions from opposed directions.

15. The projector according to claim 12,
wherein the metal foil member comprises
a body portion, and
an end portion that is connected to one end of the body portion, and has first and second portions extending approximately parallel to each other approximately along an extending direction of the axis of the electrode, and
the first and second portions hold the root portion of the electrode in a manner of sandwiching the portion from opposed directions.

16. The projector according to claim 12,
wherein the end portion of the metal foil member has first and second portions formed by cutting an end portion of one foil sheet in two approximately along an extending direction of the axis of the electrode, and
the first and second portions hold the root portion of the electrode in a manner of sandwiching the portion from opposed directions.
